(19) United States
(12) Patent Application Publication
(10) Pub. No.: US 2020/0256755 A1
(43) Pub. Date: Aug. 13, 2020

(54) RIBBON TYPE SENSOR

(71) Applicant: ABLIC Inc., Chiba-shi (JP)

(72) Inventors: Yoshihide WAKAYAMA, Tokyo (JP); Teruo YAMAMIYA, Tokyo (JP); Takashi HASEBE, Tokyo (JP); Shozo NISHIYAMA, Tokyo (JP); Toshihiko UEDA, Tokyo (JP); Yusuke TAKEUCHI, Chiba-shi (JP); Taro YAMASAKI, Chiba-shi (JP); Norihiro OKAZAKI, Chiba-shi, (JP); Fumiyasu UTSUNOMIYA, Chiba-shi (JP); Ryo YAMAMURA, Echizen-shi (JP); Kouichi TAKAHASHI, Echizen-shi (JP)

(21) Appl. No.: 16/786,770

(22) Filed: Feb. 10, 2020

(30) Foreign Application Priority Data
Feb. 12, 2019 (JP) 2019-022876

(51) Int. Cl. G01M 3/16

(52) U.S. Cl. CPC G01M 3/165

(57) ABSTRACT

A parasitic ribbon sensor includes: a first conductive line including a first metal portion formed of a first metal; and a second conductive line including a second metal portion formed of a second metal being different from the first metal, the second conductive line being placed parallel to the first conductive line, being shaped in a ribbon shape together with the first conductive line.

### CROSS-REFERENCE TO RELATED APPLICATIONS

The present application claims priority to Japanese Patent Application No. 2019-022876, filed Feb. 12, 2019, the disclosure of which is incorporated herein by reference in its entirety including any and all particular combinations of the features disclosed therein.

### BACKGROUND

### Field of the Invention

The present invention relates to a ribbon-shaped sensor. In particular, it relates to an electromotive sensor.

### Description of the Related Art

For sensors that detect water leakage, etc., those designed with two electrodes for detecting moisture between the electrodes by measuring the electrical resistance between the electrodes, are used.

For example, Patent Literature 1 (Japanese Patent Laid-open No. 2008-233031) discloses a water leakage detection system comprising: multiple water leakage detection sensors that are connected in series and will each become electrically continuous when water leakage occurs, thus allowing the location of the water leakage to be identified from its resistance value; an information reading means for reading the position detected by the water leakage detection sensor; and a storage means for storing the information read by the information reading means.

Patent Literature 2 (Japanese Patent Laid-open No. 2016-45136) discloses a moisture detection sensor comprising two metal wires that are placed in close proximity to each other by sandwiching an insulator body in between.

Patent Literature 3 (Japanese Patent Laid-open No 2013-167551) discloses a detected-data transmission/aggregation system using a self-powered water leakage detection sensor in an underground facility, wherein such system is characterized in that it has: (a) a self-powered water leakage detection sensor that generates electricity when water leakage occurs in an underground facility; (b) a wireless transmitter that transmits the detected data using, as a source of power, the voltage generated by the self-powered water leakage detection sensor; and (c) a notification device with a wireless receiver that receives the data transmitted by the wireless transmitter.

Patent Literature 4 (Japanese Patent Laid-open No. 2001-296201) discloses a water leakage detector comprising an electrode part whose electrical characteristics change when water leakage occurs, and a circuit that detects and discriminates changes in the electrical characteristics, wherein the electrode part comprises a negative electrode of low standard electrode potential and a positive electrode of high standard electrode potential, based on the electrochemical series, and the inductive electrical potential difference resulting between the positive electrode and the negative electrode from the water leakage is amplified and discriminated to obtain a detection signal.

### BACKGROUND ART LITERATURES

[Patent Literature 1] Japanese Patent Laid-open No. 2008-233031

[Patent Literature 2] Japanese Patent Laid-open No. 2016-45136

[Patent Literature 3] Japanese Patent Laid-open No 2013-167551

[Patent Literature 4] Japanese Patent Laid-open No. 2001-296201

### SUMMARY

An object of the present invention is to develop a parasitic sensor which is embodied as follows.

1. A ribbon sensor comprising: a first conductive line including a first metal portion formed of a first metal; and a second conductive line including a second metal portion formed of a second metal being different from the first metal, the second conductive line being placed parallel to the first conductive line, being shaped in a ribbon shape together with the first conductive line.

2. The ribbon sensor according to 1, wherein the first and second conductive lines are embedded in a nonconductive woven fabric.

3. The ribbon sensor according to 1, wherein the first metal is one selected from zinc and zinc-based metal, and wherein the second metal is one selected from silver and silver-based metal.

4. The ribbon sensor according to 1, wherein the first conductive line is formed of one selected from zinc and zinc-based metal.

5. The ribbon sensor according to 1, wherein the first conductive line is formed of a fiber with one selected from zinc and zinc-based metal, the one being deposited on a surface.

6. The ribbon sensor according to 1, wherein the second conductive line is formed of one selected from silver and silver-based metal.

7. The ribbon sensor according to 1, wherein the second conductive line is formed of a fiber with one selected from silver and silver-based metal, the one being deposited on a surface.

8. The ribbon sensor according to 1, wherein the first and second conductive lines are twisted wires.

9. The ribbon sensor according to 2, wherein the woven fabric is made of polyethylene terephthalate fibers.

10. The ribbon sensor according to 1, wherein exposed portions of the first and second conductive lines are provided on a ribbon.

11. The ribbon sensor according to 1, further comprising a connection plug provided at one end or both ends of the first conductive line.

12. The ribbon sensor according to 1, further comprising a connection plug provided at one end or both ends of the second conductive line.

13. A water leakage sensor being constituted by the ribbon sensor according to 1.

14. A self-transmitting sensor comprising: the ribbon sensor according to 1; and an IC tag including an electricity-storing element, a step-up circuit, and a transmitting element.

15. A detection system comprising: the self-transmitting sensors according to 14; a relay installed within a range reachable by signals transmitted from the self-transmitting sensors; and a receiver configured to receive the signals from the relay.

Furthermore, such self-transmitting sensors may be used to constitute detection systems for buildings, etc. Examples include:

16. A detection system according to 15, wherein it detects water leakage.

17. A water leakage detection system for structures, wherein it is a detection system according to 16 and that its ribbon sensors are placed in locations presenting water leakage risks in a structure.

1) The present invention realizes a parasitic sensor constituted by a ribbon made of insulating fibers, embedded with metal wires of different types in the longitudinal direction. When the metal wires of different types come in contact with water, an electrical potential difference occurs and electricity is generated in the same way explained by the principle of voltaic cells, and the sensor will function by utilizing this electricity. Since the present invention uses thin metal wires or metal fibers as the metal wires, it can be handled just like any textile ribbon. Since it is parasitic, the sensor can be utilized even when there is no power supply nearby; additionally, concerns over earth leakage, etc., are eliminated and the burden of maintenance is reduced. Because the ribbon sensor permits length adjustment, a long section of masonry joint, pipe, etc., can be covered.

The electromotive force can be increased by increasing the number of metal wires of different types.

For the metals of different types, metals of different ionization tendencies can be selected and, for example, zinc and silver are combined. The metals may be individual metals, or thin metal wires constituted by fibers whose surface is deposited with a metal by means of vapor deposition, coating, etc.

For the insulating fibers, natural fibers such as cotton, or synthetic fibers such as polyethylene, may be used.

2) The metal wires of the respective metal types are independently bundled together, to provide a terminal part, which serves as a connection part with an IC tag or other device having a transmitting function. Particularly when the metal wires of the different types are bundled on the top and bottom of the ribbon, respectively, the presence of the insulating ribbon in between reduces the short-circuiting risk and facilitates handling on site. A terminal part is provided at one end, or both ends, of the ribbon as a connection part. If a terminal part is provided at both ends, one serves as a male plug, while the other serves as a female plug. If a plug is provided at both ends, such ribbons can be connected and extended to support various lengths.

3) This ribbon sensor generates electricity on its own when it comes in contact with water, which can be utilized to make this a water leakage sensor, etc. By attaching an IC tag housing an electricity storing element that stores the self-generated electricity, a step-up circuit that steps up the voltage of the stored electricity, and a transmitting element that transmits via the step-up circuit, a parasitic sensor that transmits a signal of water leakage will be constituted. Electricity is stored and its voltage stepped up because the transmitting element cannot be activated directly with the amount of electricity generated by the ribbon sensor.

4) Furthermore, the sensor proposed by the present invention can be applied for a water leakage detection system incorporated into a building, etc., or for a diaper, etc.

(1) A water leakage detection system can be constituted by installing, in a monitoring center, a receiver that receives the signals transmitted by this water leakage sensor via a relay, and placement of such water leakage detection system in a building or other structure allows for easy detection of water leakage.

In the event that rainwater, etc., enters and leaks into a building, identifying the entry route of water is difficult. Since water penetrating from the outside travels through whatever passable route it can find to reach a location where it leaks, identifying the first location of entry is not easy. When the ribbon sensor proposed by the present invention is placed at a masonry joint, on a ceiling, or in other places inside a building, water can be detected near the location of entry, thus making it easy to implement measures against water leakage.

Since the ribbon sensor proposed by the present invention generates electricity on its own, no power supply equipment is required. An energy-efficient water leakage detection system can be constructed.

Also, it can be installed in a water suction pipe, water drain pipe, or other piping system to construct a water leakage detection system that allows for early detection of water leakage.

(2) Applying the ribbon sensor for diapers, sheets, etc., improves the convenience of residents in, and also facilitates the management of, care facilities, nursery schools, etc. The parasitic sensor is safe, as it eliminates the danger of electric shock. In applications requiring frequent replacement, the ribbon sensor shall be designed so that its ribbon part is replaceable with respect to the IC tag. Since urine contains a lot of electrolytes, more electricity is generated, which leads to a higher sensitivity.

### BRIEF DESCRIPTION OF THE DRAWINGS

FIG. 1 is a basic structural diagram of a ribbon sensor

FIGS. 2A to 2B are structural diagrams of a multi-row ribbon sensor

FIG. 3 is an example of weave of a multi-row ribbon sensor

FIGS. 4A to 4B are diagrams of weave structure

FIGS. 5A to 5C are diagrams of weave structure of a metal-wire embedded part

FIGS. 6A to 6B are examples of a self-transmitting sensor

FIGS. 7A to 7B are examples of a ribbon sensor

FIGS. 8A to 8B are ribbon sensors with tags

FIG. 9 is a structural diagram of a water leakage system

FIG. 10 is a diagram of water leakage detection flow

### DESCRIPTION OF THE SYMBOLS

1 Ribbon sensor
11 Parallel ribbon sensor
12 Multi-row ribbon sensor
12a Sensing part
12b Insulating part
13 Take-out line
13a Zn line
13b Ag line
14 Plug
2 Metal wire
2a Metal wire A
2b Metal wire B
21 (21a to 21e) Metal wire A (Zn)
21a Zinc-wire exposed part
22 (22a to 22e) Metal wire B (Ag)
22a Silver-wire exposed part
23 PET fiber
31 Hollow textile body
32 Joining part
33 Sensing part
34 Weft (fiber)
35 Selvage
4 IC tag
41 Electricity storing element
42 Step-up circuit
43 Transmitting element
5 Ribbon sensor with IC tag
51a, 51b, 51c, 51n Ribbon sensors with IC tags
6 Gateway
7 Structural diagram of water leakage detection system
71 Cloud
72 Mobile terminal
72a Smartphone
72b Mobile device
73 Central monitoring system
101 Water droplet
230 Structure, etc.

### DETAILED DESCRIPTION OF EMBODIMENTS

The present invention is an self-electrogenic ribbon sensor constituted by a ribbon made of insulating fibers, embedded with metal wires of different types in the longitudinal direction. The sensor works in such a way that, when the sensor comes in contact with water, it generates electricity which is then detected. Because the sensor generates electromotive forces on its own, it need not be supplied with electricity and is therefore suitable for locations where there is no power supply or where installing a power supply is not desirable.

The present invention is a self-transmitting sensor that transmits signals, produced by attaching to a ribbon sensor an IC tag housing an electricity storing element and a transmitter. It constitutes a detection system wherein the transmitted signals are received, via a relay, etc., at a management center, etc.

Also, the present invention can be applied to a detection system constituted by ribbon sensors or self-transmitting sensors installed at various locations in a structure or a care facility, so that they can be managed by a central monitoring center or maintenance personnel.

<Ribbon Sensor>

Metal wires of different types having different ionization tendencies are placed in parallel in a ribbon shape, to constitute a self-electrogenic ribbon sensor. The present invention utilizes the phenomenon that metals having different ionization tendencies generate an electromotive force when they come in contact with water, etc. Since the sensor is formed in an elongated ribbon shape, it can be used under the roof of a structure or along a pipe or other long object. Additionally, because it requires no external power supply, battery, etc., the sensor imposes few restrictions and generates little discomfort when used on the human body, thus ensuring a greater degree of freedom and safety.

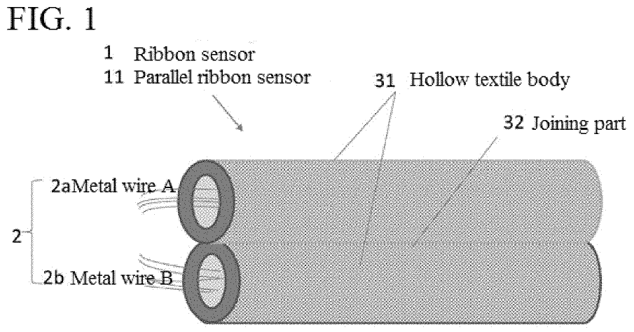

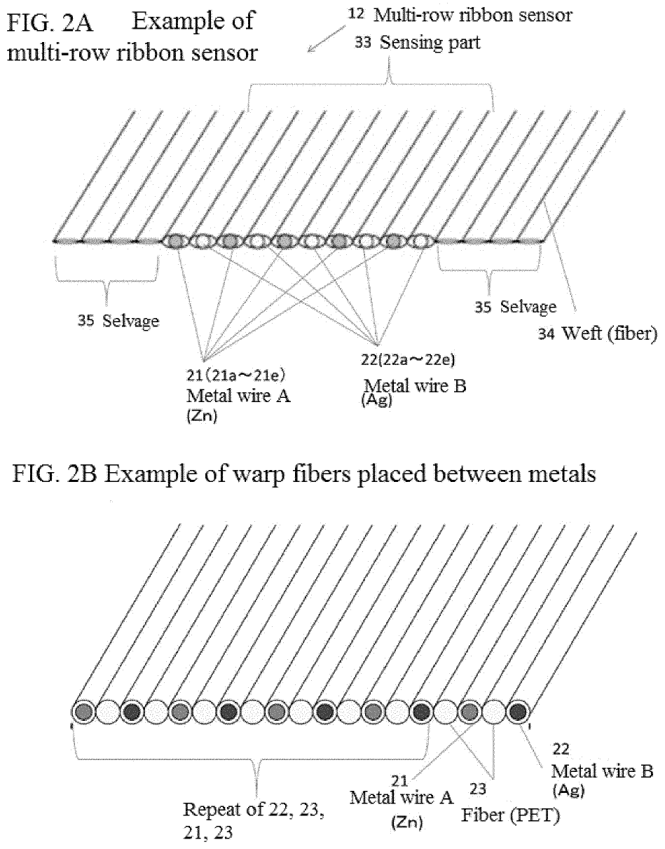

Examples of modes of ribbon sensors are shown in FIG. 1 and FIGS. 2A to 2B.

FIG. 1 shows a ribbon sensor 1 wherein metal wires A 2a and metal wires B 2b are stored separately in hollow textile bodies 31, and a joining part 32 is formed between the hollow textile bodies.

For the textile, a material offering excellent insulating property, such as cotton or synthetic fiber, is used. The hollow textile bodies 31 need not be completely hollow, and are structured in such a way that metal wires A 2a and metal wires B 2b are separated to prevent contact and that water can permeate through to wet both metal wires 2.

Accordingly, the hollow textile bodies may each be constituted by a fabric that is knitted or woven in a tube shape, cloth formed in a tube shape, knitted fabric, woven fabric, etc. They can be formed by placing the metal wires in the length direction and then weaving or knitting fibers thereto.

The hollow bodies are provided with a joining part in the middle so that they can be placed close to each other. The joining part is continuously knitted or woven, sewn, fused, etc. The joining part may be provided in a band shape, but a close contact design is suitable for generating electricity because the distance between the metal wires of different types becomes shorter.

For the metal fibers, monofilaments, multi-filaments consisting of many thin filaments, twisted wires, metal fibers constituted by plated fibers, etc., may be used. Multi-filaments, and twisted wires formed by twisting filaments, are suitable as they reduce the risks of kinked wiring and wire breakage.

The ribbon sensor using metal wires of different types is flexible, presents reduced wire breakage risks, and demonstrates sensor function over its entire length, which makes it an effective sensor when there is a need to monitor a long distance over its entirety.

The ribbon sensor may be formed long, with no limitation placed on the length. Also, sensors of several different lengths, each having a certain length, can be formed and used in combination.

The metal wires are bundled and fit in a plug at an end part of the ribbon sensor for connection with the detection part or measuring part of an IC tag, etc. Male and female plugs may be provided and placed at both ends of the ribbon sensor, so that such ribbon sensors can be connected to adjust the length. Additionally, when conducting a product inspection or installation performance test, the presence of plugs at both ends permits testing of electrical continuity simply by bringing one end in contact with a power supply, which is also ideal when conducting installation work.

FIGS. 2A to 2B show a multi-row ribbon sensor 12 in which many metal wires are placed.

In the example of FIG. 2A, a multi-row ribbon sensor 12 is shown wherein multiple thin zinc wires 21 (21a to 21e) and multiple thin silver wires 22 (thin silver-plated resin fiber wires) (22a to 22e) are placed alternately as metal wires, and selvages 35 consisting only of fibers are formed on both sides. The selvages are not always required. The part where the metal fibers are embedded constitutes a sensing part 33. FIG. 4A shows a diagram of this weave structure.

Providing multiple combinations of two types of metals increases the amount of electricity generated.

The selvages may be provided to secure the ribbon sensor in place. When fastening the sensor with a tacker, for example, staples can be driven into the selvages to avoid wire breakage and short-circuiting of the metal wires. Also, presence of the selvages improves the water absorptivity and retentivity, which helps shorten the time to generation of electricity and extend the generation time.

FIG. 2B gives an example where a PET fiber 23 is positioned between the silver wire 22 and the zinc wire 21. The type in FIG. 2A generates more electricity because the distance between the metal wires of different types is shorter. The type in FIG. 2B provides higher insulating property in a normal state, although electricity production is suppressed by the increased distance between the metal wires. Also, the PET fibers in between increase the fiber quantity, which improves the water retention capability to allow the moisture from water leakage to be retained for a long time, while the generation time is also extended to secure enough electrical capacitance needed for transmission. When harder metal wires are used, the risk of short-circuiting caused by adjacent metal wires contacting each other at a bent part can be mitigated by positioning fibers in between. Also, use of a corrosion-prone metal may cause corrosion-induced blisters or rust juice to contact the adjacent metal, in which case positioning fibers in between also improves avoidance of short-circuiting.

Besides the above, prototype multi-row ribbon sensors combining different numbers of wires, such as one zinc wire and five silver wires, were produced and tested. They were able to generate electricity, which suggests application potential, but the resulting electricity productions were low.

<Types of Metals>

Metals, which are used in a combination that causes an electrical potential difference to generate between the two types of metals, may be selected according to the order of electrical conductivity.

Wire-shaped metals such as thin wires and fiber-shaped ones are suitable, and silver-plated and other plated wires may also be utilized. Silver and aluminum may also be vapor-deposited on synthetic resins.

For example, the combination may be silver-zinc, silver-aluminum, copper-aluminum, zinc-stainless steel, etc. Furthermore, when combinations of conductive carbon group fibers with zinc or silver were tested, the obtained electromotive forces were smaller than those based on metal-metal combinations.

For the metals, metals themselves, or base materials whose surface is coated, plated, or otherwise deposited with a desired metal, may be used. For example, fibers may be used as a base material to be plated. Plated fibers are elastic, flexible and easily adaptable in a ribbon. Metals that can be coated by means of vapor deposition include aluminum, silver, copper, chromium, tin, nickel, zinc, and the like. Zinc includes a zinc-based (or zinc group) metal. Silver includes a silver-based (or silver group) metal. Likewise, in this disclosure, a metal element M includes a M-based or M group metal.

For example, silver-plated nylon 6.6 fibers may be used as silver wires. Featuring both the physical characteristics of nylon and the characteristics of silver, these wires are flexible and strong when bent, have high tensile strength, and thus do not fracture easily.

Each metal is used as a wire material continuing in the longitudinal direction of a ribbon. The thickness of the wire material is not limited in any way, but a thin wire is suitable in consideration of possible uses in curved parts. Also, as a metal wire is used by weaving or knitting with the fibers from which to form a ribbon, it can adapt better if thinner. The mainstream mode is to use a bundle of multiple metal wires in a row, but there may be only one metal wire.

The metal wires may be used as single wires or twisted wires. Use of twisted wires improves fracture resistance and also increases the metal surface due to twisting, leading to increased generation output.

<Types of Fibers>

For the fibers used as a base material from which to form a ribbon, nonconductive fibers that exhibit water permeability and retentivity upon contact with water are used. Natural fibers and synthetic fibers are generally nonconductive. The fibers constitute a base material from which to form a ribbon, and have a function to separate the two types of metals to prevent their contact, as well as a function to let the two types of metals, once they come in contact with water, remain in contact with water. Although the density matters, fibers that are highly hydrophobic or water-repellent are not suitable. Since keeping the fibers wet is also important in allowing the electrons to migrate between the two metals, hydrophilicity and water retentivity are also important factors.

Specific examples of fibers include polyethylene fibers, polyethylene terephthalate fibers, polytrimethylene terephthalate fibers, polybutylene terephthalate fibers, polyester elastomer fibers, polyamide fibers, polyacrylic fibers, polypropylene fibers, and other synthetic fibers; cotton, linen, wool, and other natural fibers; cuprammonium rayon, viscose rayon, Lyocell, and other recycled fibers; and such other fibers as may be desired, where multiple types of fiber materials may be blended. Also, elastic polyurethane fibers, elastic polyolefin fibers, elastic natural rubber, and synthetic rubber fibers, etc., may be combined in order to add stretching property. Any known fibers may be selected, so long as they are nonconductive.

Suitable fibers include polyethylene and polyethylene terephthalate (PET).

These fibers may be used as bundled single fibers, or as twisted wire form.

These fibers are formed into a ribbon shape by means of weaving or knitting. Thin metal wires are embedded in the longitudinal direction as a ribbon is formed, to form a ribbon sensor. For example, a ribbon sensor may be formed by weaving thin metal wires and fiber wires, which are used as warp, with fiber wires, which are used as weft.

<Examples of Weave Structure of Ribbon Sensor>

The weave of metal wires embedded in a ribbon may be created by using thin metal wires as a part of warp, as a rule. Various weaving means, ranging from a simple weaving means featuring intersecting warp and weft, to a weaving in a manner enclosing the peripheries of thin metal wires, may be used. It should be noted that a wire which has the attributes of a “metal” is simply referred to as a “metal wire.”

Regarding the method for exposing the metal wires on the top and bottom of the ribbon for use as terminals, these areas may be created by providing parts where no metal wires are weaved in. Also, exposed parts and exposed lengths of metal wires may be created at any intervals as deemed appropriate. In other words, exposed parts of metal wires may be set at a desired pitch such as 1 m or 50 cm. The metal wires may be cut to the necessary lengths to adjust their lengths. Since the different types of metals are exposed on the top and bottom of the ribbon, respectively, the two metals will not contact each other and remain insulated. It should be noted that, if the sensor is used with the metal wires exposed midway through the ribbon, preferably they are covered with an insulating tape, etc., to prevent contact with any metal in the surroundings. FIG. 4B shows an example where the metal wires are exposed in the middle of the ribbon. In this example, silver wires are exposed on the top side, while zinc wires are exposed on the bottom side.

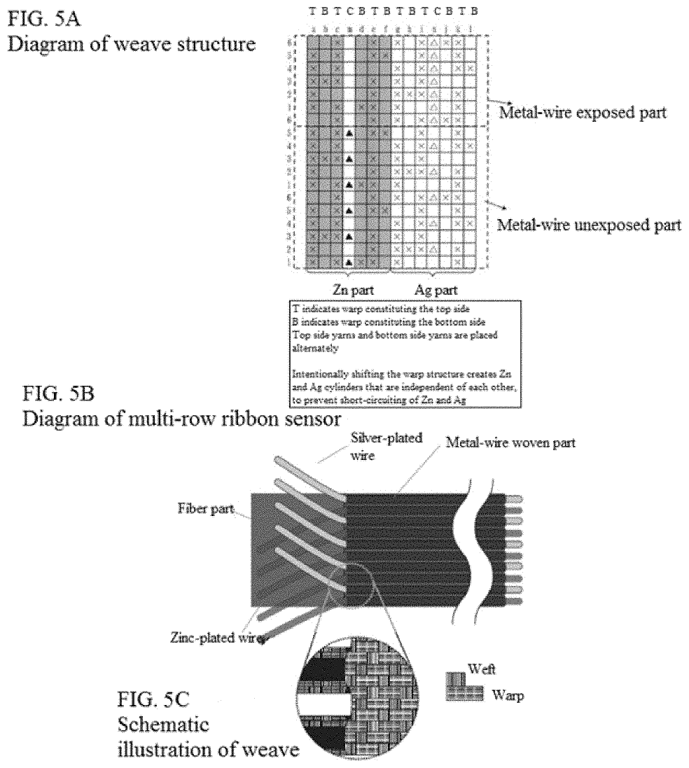

FIG. 4A shows an example of a diagram of weave structure, while FIG. 4B provides a schematic illustration of an example where the metal wires are exposed in the middle of the ribbon. Furthermore, FIG. 5A shows an enlarged view of the diagram of weave structure of the metal wire-embedded part in FIG. 4A, FIG. 5B provides a schematic illustration of the structure of a multi-row ribbon sensor, and FIG. 5C provides an enlarged schematic illustration of the condition of weave. As a result of such weave, the metal wires are positioned at the core part, while the zinc wires and silver wires are enclosed by independent cylinders, and consequently short-circuiting is prevented. Also, the mode where the metal fibers are enclosed by the warp and weft, and the parts where the metal wires are exposed on the top and bottom, can be woven differently.

The woven fabric is made by passing the weft in the direction crossing at right angles with the warp. In the example of the diagram of weave structure shown in FIG. 4A, the warp takes the position above or below the weft, and how this pattern varies every time the weft is passed is indicated by an X mark, etc. The weave structure of the fabric in this diagram is such that the PET yarn indicated by an X mark, Zn wire indicated by a ▴ mark, and Ag wire indicated by a Δ mark, are going above the weft at a marked location, while going below the weft at a blank location.

<Basic Test 1>

Prototype test specimens (a), (b), (c) were made according to the parallel ribbon sensor shown in FIG. 1. The three types of test specimens, using cotton fibers, zinc wires, and stainless steel wires in the case of (a), cotton fibers, zinc wires, and silver wires (silver-coated nylon fibers) in the case of (b), and PET fibers, zinc wires, and silver wires in the case of (c), were tested for water absorptivity and generation capacity

While test specimens (a), (b) generated electricity, test specimen (c) absorbed more water and generated more electricity. Accordingly, the combination of PET fibers, zinc wires, and silver wires is adopted.

<Basic Test 2>

Prototypes were made and tested for flexibility and other usability features by considering the usage modes of fibers in multi-row ribbon sensors.

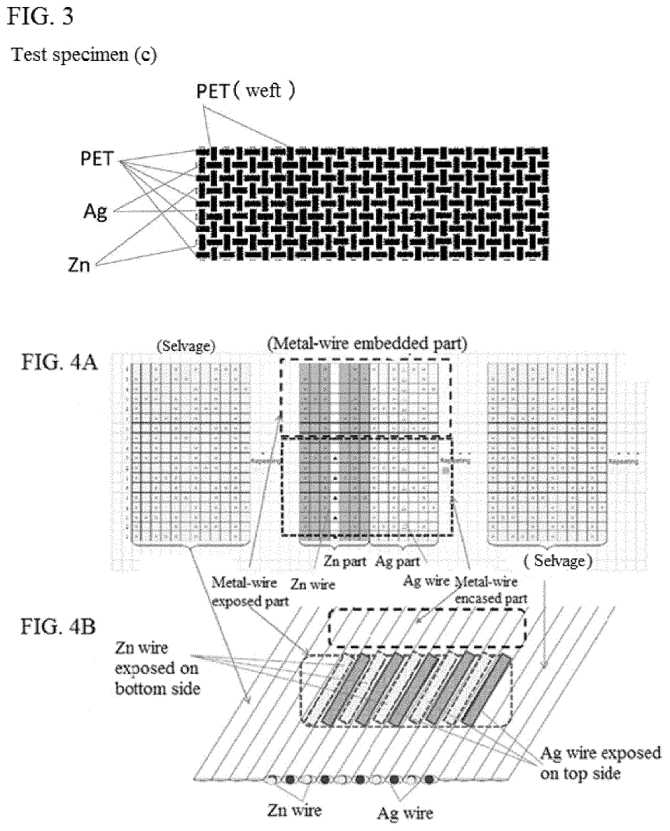

Test specimen (c) (FIG. 3) was woven using PET fibers as weft, as well as alternating silver and zinc wires with PET fibers placed in between, as warp.

Test specimen (d) (FIGS. 2A to 2B) has PET fibers placed in a manner surrounding silver and zinc wires.

Test specimens (c), (d) presented good water absorptivity and generation output, but when test specimen (c) was bent strongly, the zinc wires projected, and on further bending, wire breakage occurred. On test specimen (d), neither wire projection nor breakage was observed. Test specimen (d) exhibited strong flexural resistance, etc., and excellent usability.

The constitution of test specimen (c) is suitable for use in straight configurations, while in places with curves and corners, the constitution of test specimen (d) is suitable.

<Self-Transmitting Sensor>

The metal wires led out from the ribbon sensor are bundled and fitted with a plug or other connection part to which an IC tag is attached, to constitute a sensor of self-transmitting type.

To the IC tag, a code identifiable for each transmitter is given. The identification code allows the installation location of the sensor to be identified.

The IC tag and ribbon sensor can be easily connected to or separated from each other, and in an application for daily use, the ribbon sensor part can be replaced. In a structure, etc., where the sensor remains installed for a long period of time, there is seldom a need for replacement.

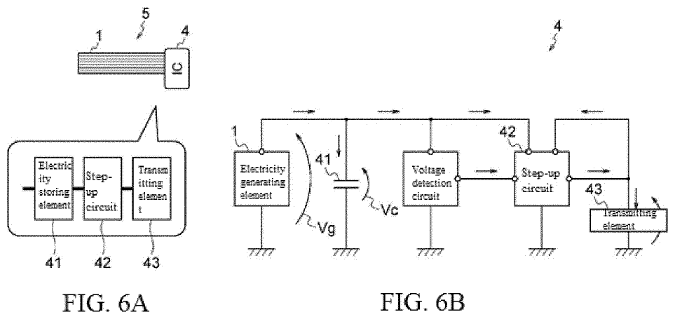

FIGS. 6A to 6B show an example of a ribbon sensor with IC tag 5. In this constitution, an IC tag 4 is installed at the tip of a ribbon sensor 1. The IC tag 4 houses an electricity storing element 41 that stores the electricity sent from the ribbon sensor 1, a step-up circuit 42, and a transmitting element 43. Once a certain amount of electricity is stored in the electricity storing element 41, the step-up circuit steps up the voltage to the level at which the transmitting element is activated and then energizes the transmitting element 43, so that the transmitting element 43 transmits a signal. The signal is received by a relay provided at a distance where it can receive the signal from the transmitting element 43. Based on the current device configuration, the receiving distance from the IC tag is approx. 10 m. This depends on the performance of devices, so the amount of electricity required for transmission, as well as the receiving distance, should improve in the future.

Electricity is stored and its voltage stepped up, because the electromotive force of the ribbon sensor is small and cannot activate the transmitting element as is. Storing electricity requires time, so signals are transmitted intermittently. The ribbon sensor generates electricity while zinc is eluting, which means that electricity storage and transmission by the IC tag occur intermittently while electricity is generating. In this test, zinc-plated steel wires were used as zinc wires, so the elution of surface zinc was followed by the ionization and elution of iron, and intermittent signals were confirmed for one week.

<Devices Constituting IC Tag>

The element constitution of the IC tag represents a structure where the electricity raised by the metal wires of different types is stored in the electricity storing element 41 which is a capacitor, etc., and once the stored electricity reaches or exceeds the capacity, it is discharged and flows through the step-up circuit 42 into the transmitting element 43, and a signal is transmitted.

The specific circuit configuration is illustrated in FIG. 6B. This circuit was developed by one of the joint applicants and disclosed in FIG. 1 of Japanese Patent Laid-open No. 2018-85888. The ribbon sensor under the present invention corresponds to the electricity generating element, and a load corresponds to the transmitting element. Also, the BLE (Bluetooth Low Energy) (Bluetooth is a registered trademark) method, etc., is used for the transmitting element. The stepped-up electric power drives the BLE-type wireless TAG, which then transmits radio waves, where currently the communication range of the BLE-type wireless TAG is approx. 10 m.

<Detection System>

The water leakage detection system is a system comprising self-transmitting sensors installed at masonry joints etc., in a structure, as well as an active relay installed within the receiving range of the signals transmitted by the self-transmitting sensors, wherein the system utilizes the Internet, cloud, or other communication system to notify the signals from the relay to the building management system, the facility manager's mobile phone or mobile PC, etc.

Able to identify the location of water leakage based on which ribbon sensor has sensed leaked water, the building management system or facility manager quickly checks the site, sends for a maintenance expert, or takes other emergency response measures.

The ribbon sensors can be installed along locations presenting water leakage risks.

Structures are exposed to risks of water leakage from roofs and rooftops, masonry joints in exterior walls, connection parts of open frames, basement walls, drinking water pipes, and sewage pipes, etc. With water service pipes, locations that require caution include branching points and seam joints, around meters, kitchens, baths, toilets, laundry drains, etc. If water leakage remains unnoticed, not only will damage spread and direct repairs be needed, but the businesses and lives of the residents and other users will also be affected significantly, which makes it important that the cause is identified and measures taken early.

Also, the present invention can be utilized for sensors that detect water leakage from the ground in tunnels and other underground facilities. It can also be utilized for water storage tanks, liquid storage facilities, water supply and drainage equipment at food factories, etc.

The foregoing explanations relate to structures, but the present invention is not limited to structures and may be utilized for general sensors that detect water absorption phenomena. The ribbon sensor is a sensor that generates a signal when it absorbs water. The ribbon sensors can be installed over a target in its longitudinal direction, for detection along a line. The ribbon sensors can also be installed in parallel for surface detection, and even the directionality of wetting can be grasped based on the order in which the detection signals are transmitted. Furthermore, the ribbon sensors can be installed in a grid so as to identify the wet location using coordinates. They can also be wrapped around cylindrical or columnar objects such as pipes.

For example, applying them to care bed sheets directly or installing them under the sheets on care beds allows for detection of accidental wetting. Furthermore, they can be attached to adult diapers, or applied to diapers for infants. This makes the job of care staff and childcare nurses easy, because they can know when to change the diapers.

### Example 1

<Ribbon Sensor>

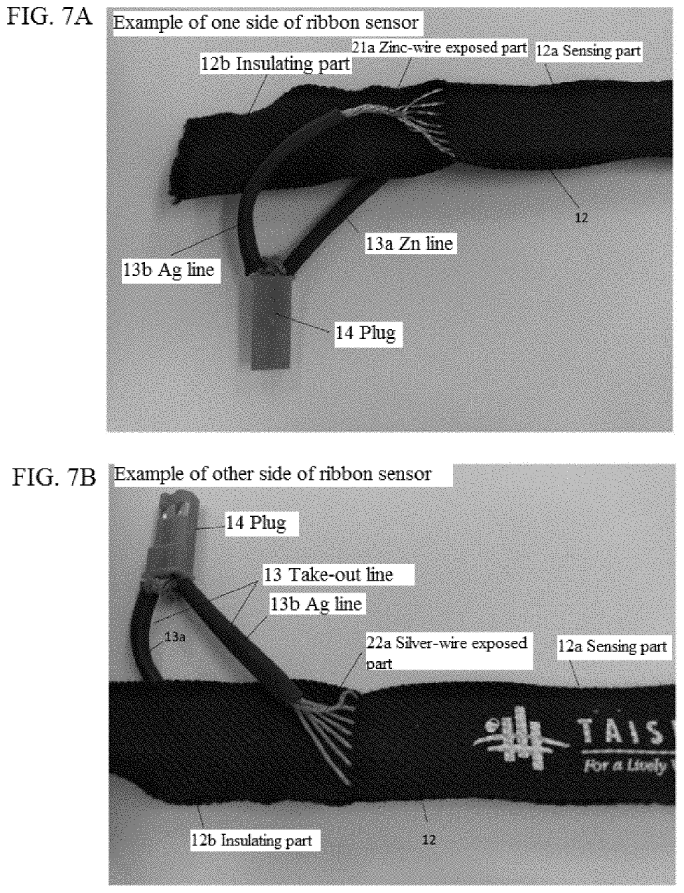

The multi-row ribbon sensor 12 in Example 1, as shown in FIGS. 7A to 7B, is constituted by seven rows of zinc wires and seven rows of silver wires (silver-coated nylon fibers) placed in an array in the vertical direction. The basic constitution of the ribbon uses PET fibers as warp and weft.

With the multi-row ribbon sensor 12, the metal wires are led out from the middle of the ribbon and the part where the metal wires are embedded serves as a sensing part 12a, while the part where no metal wires are embedded serves as an insulating part 12b which lies between the led-out metal wires to prevent them from contacting each other. The led-out metal wires are twisted into single strands, on which protective tubes are installed and a plug 14 is attached at their tips.

FIG. 7A shows one side of the multi-row ribbon sensor on which the zinc wires are exposed. The exposed zinc wires are bundled into a zinc-wire exposed part 21a, and a protective tube is placed over the bundled zinc wires to provide a zinc line 13a which converges into the plug 14. FIG. 7B shows the other side of the multi-row ribbon sensor on which the silver wires are exposed. The exposed silver wires are bundled into a silver-wire exposed part 22a, and a protective tube is placed over the bundled silver wires to provide a silver line 13b which converges into the plug 14.

For the zinc wires, four single zinc-plated steel wires are twisted and placed in a single row, while the silver wires are twisted wires consisting of eight silver-coated multi-filaments. They are woven with the PET fibers into a ribbon of 14 mm in width. The zinc wires and silver wires are surrounded by the PET fibers, so that the respective metal wires are not exposed to the surface.

On the terminal part side, the zinc wires and silver wires are exposed on the top and bottom of the ribbon, respectively, and then bundled, and the plug is attached. The plug serves as a terminal for connecting to an IC tag. The ribbon terminal part is located between the zinc wires and the silver wires and serves as an insulating layer that prevents the two from contacting each other.

This ribbon sensor is such that its metal wires, which are enclosed by the flexible PET fibers, demonstrate good wire breakage resistance and do not break easily. The sensor conforms well when installed in a building, etc., and it seldom presents problems and rarely malfunctions.

### Example 2

<Self-Transmitting Sensor>

A ribbon sensor of self-transmitting type, comprising the ribbon sensor described in Example 1 and an IC tag attached thereto, was prepared and tested for electromotive force and transmission by dripping water droplets onto the ribbon part. For the IC tag, one whose element constitution is shown in FIGS. 6A to 6B was used.

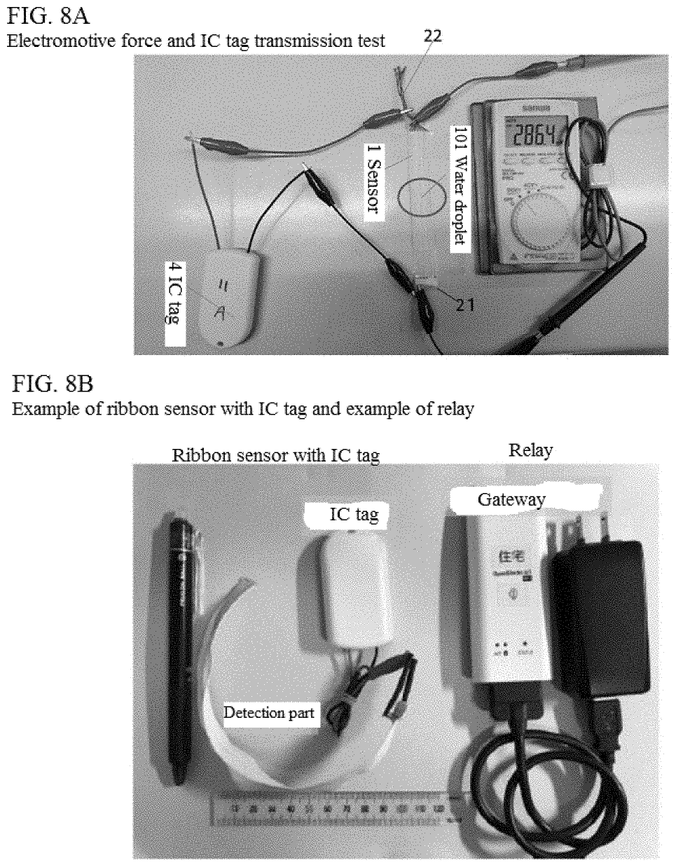

The test was conducted using the prototype sensor model shown in FIG. 8A. The IC tag 4 was connected to the silver electrode to which the silver wires 22 had been led out, and to the zinc electrode to which the zinc wires 21 had been led out, provided on both end sides of the ribbon sensor 1. An electromotive force measurement tester was also connected.

When water droplets 101 were dripped onto the center of the ribbon sensor or thereabout, an electromotive voltage was measured. The dripped amount of water droplets 101 was 0.1 to 0.2 ml. The elapsed time following the dripping of tap water, until the voltage rose gradually and reached around 0.7 V, and a signal was transmitted from the IC tag, was measured.

A signal was transmitted from the IC tag 4 in 5 minutes 45 seconds, which could be received by a mobile terminal and PC via a relay gateway.

Transmission continued intermittently at intervals of a little less than 6 minutes, confirming that transmission would continue while the sensor is wet.

Notification of water leakage in a building, etc., in 5 to 6 minutes is sufficiently practical.

Several other constitutions were tested. For example, the transmission time was 5 minutes 40 seconds when one zinc wire and eight silver wires were combined, and 2 minutes 25 seconds when six zinc wires and five silver wires were combined, and the like. In all cases, transmission was continuous. Also, the ribbon sensor combining five zinc wires and five silver wires shown in FIG. 2B, which is of the type having PET fibers placed between the thin metal wires, took 5 minutes 15 seconds until transmission. Although the time became slightly longer due to increased intervals between the zinc wires and the silver wires, it is still sufficiently practical.

The sensor can be used by adjusting the quantity combination of the thin metal wires, their insulating intervals, and so on.

FIG. 8B shows an example of the developed ribbon sensor with IC tag and a relay. So far, the size of the IC tag has been reduced to approx. 2 to 3 cm×4 to 6 cm (roughly a half the size of a business card) and the thickness of the ribbon part, to approx. 0.3 mm. Although the ribbon is 13 mm wide in this example, it can be set to any width according to the number of thin metal wires, etc.

<Application Example of Water Leakage Detection System>

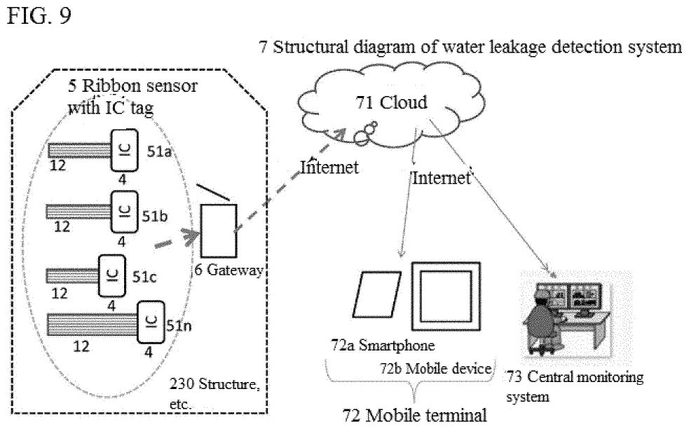

As an application example, a concept of a water leakage detection system is shown in FIG. 9.

Ribbon sensors with IC tags 5 (51a, . . . , 51n) are installed in locations presenting water leakage risks in a structure, and a gateway 6 that serves as a relay is installed within communication range (such as within 10 m) of the ribbon sensors with IC tags 5, where this gateway 6 is supplied with electricity and made accessible to a cloud 71 or other Internet system. This system utilizes the cloud 71 or other system to transmit water leakage information to the central monitoring system 73 for a facility or security personnel's smartphone 72a, mobile device 72b, or other mobile terminal 72. The IC tags 4, 4, 4 . . . are each assigned a unique identification code.

The ribbon sensors with IC tags 51a to 51n are parasitic in that they transmit on their own based on their own electrogenic forces, which makes power distribution equipment no longer necessary when the sensors are installed, improves the degree of freedom regarding the placement of sensors in the building, and eliminates the risks of earth leakage accidents and other electrical system trouble. The gateway 6 must be supplied with electricity, but any existing power supply equipment can be used and installed in a readily accessible location to allow for easy maintenance.

This water leakage detection system may be installed where there are high water leakage risks, such as kitchens, baths, toilets, cooking areas, and other indoor locations, upright drain pipes, upright clean water pipes, service pipes, and other piping lines, rooftop waterproofing, bases of water drain pipes, roofs, around windows, and other opening areas, and the like. It may also be used outdoors with the sensors serving to detect breakage of water-impervious sheets at disposal sites, and the like.

For example, flooding of an electrical room at a train management facility can have significant effects on social activities as various equipment may stop operating and the train service may halt, and so on. Accordingly, this system should be installed to cover station equipment, etc., where there are flooding risks.

Also, the system may be installed in basements, underground walkways, tunnels, underground stations and other operating facilities. For example, the sensors may be installed on drain channels near the covers or on the exterior walls to sense overflow risks and overflows.

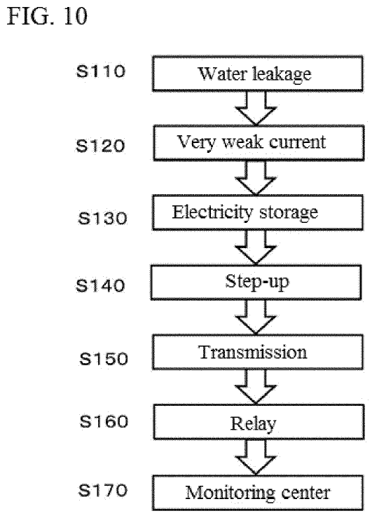

FIG. 10 shows a water leakage detection flow.

When the ribbon sensor with IC tag installed in the location of water leakage gets wet (S110), a very weak current is produced due to the electromotive force generated by the sensor itself (S120), and which is then stored in the electricity storing element in the IC tag (S130) and its voltage is stepped up (S140), and once the electrical capacitance exceeds a certain level, the transmitting element in the IC tag is energized and a signal is transmitted (S150), after which the signal is received by the relay, further transmitted from the relay (S160), and notifies the monitoring center via the cloud, etc. (S170).

Hence, according to this water leakage detection system, wetting of the ribbon sensor with IC tag following an occurrence of water leakage causes the sensor to generate an electromotive force on its own and a very weak current flows and is stored in the electricity storing element in the IC tag, and as the electricity is stored, its voltage is stepped up and the current flows to the transmitting element which then transmits a signal, and this signal is received by the relay gateway and notifies the cloud, and the water leakage signal is transmitted to the monitoring center. At the monitoring center, the location where the water leakage occurred can be identified based on which IC tag the identification code belongs to. A further investigation within the installed length of the ribbon sensor can shed light on the detailed location of the water leakage, allowing for early implementation of countermeasures before the water leakage accident escalates.

We/I claim:

1. A ribbon sensor comprising:
a first conductive line including a first metal portion formed of a first metal; and
a second conductive line including a second metal portion formed of a second metal being different from the first metal, the second conductive line being placed parallel to the first conductive line, being shaped in a ribbon shape together with the first conductive line.

2. The ribbon sensor according to claim 1, wherein the first and second conductive lines are embedded in a nonconductive woven fabric.

3. The ribbon sensor according to claim 1, wherein the first metal is one selected from zinc and zinc-based metal, and wherein the second metal is one selected from silver and silver-based metal.

4. The ribbon sensor according to claim 1, wherein the first conductive line is formed of one selected from zinc and zinc-based metal.

5. The ribbon sensor according to claim 1, wherein the first conductive line is formed of a fiber with one selected from zinc and zinc-based metal, the one being deposited on a surface.

6. The ribbon sensor according to claim 1, wherein the second conductive line is formed of one selected from silver and silver-based metal.

7. The ribbon sensor according to claim 1, wherein the second conductive line is formed of a fiber with one selected from silver and silver-based metal, the one being deposited on a surface.

8. The ribbon sensor according to claim 1, wherein the first and second conductive lines are twisted wires.

9. The ribbon sensor according to claim 2, wherein the woven fabric is made of polyethylene terephthalate fibers.

10. The ribbon sensor according to claim 1, wherein exposed portions of the first and second conductive lines are provided on a ribbon.

11. The ribbon sensor according to claim 1, further comprising a connection plug provided at one end or both ends of the first conductive line.

12. The ribbon sensor according to claim 1, further comprising a connection plug provided at one end or both ends of the second conductive line.

13. A water leakage sensor being constituted by the ribbon sensor according to claim 1.

14. A self-transmitting sensor comprising:
the ribbon sensor according to claim 1; and
an IC tag including an electricity-storing element, a step-up circuit, and a transmitting element.

15. A detection system comprising:
the self-transmitting sensors according to claim 14;
a relay installed within a range reachable by signals transmitted from the self-transmitting sensors; and
a receiver configured to receive the signals from the relay.

16. A detection system according to claim 15, wherein it detects water leakage.

17. A water leakage detection system for structures, provided with the detection system of claim 16, wherein its ribbon sensors are placed in locations presenting water leakage risks in a structure.
